(19) United States
(12) Patent Application Publication
(10) Pub. No.: US 2019/0116784 A1
(43) Pub. Date: Apr. 25, 2019

(54) METHOD OF CONDITIONING A DONOR HEART

(71) Applicant: JOINT STOCK COMPANY "NATIONAL RESEARCH CARDIACSURGERY CENTER", Astana (KZ)

(72) Inventors: Yuriy Vladimirovich Pya, Astana (KZ); Rymbay Bolatovich Kaliyev, Astana (KZ); Serik Temirkhanovich Bekbossynov, Astana (KZ); Timur Dostaevich Lesbekov, Astana (KZ); Zhuldyz Askarovna Nurmykhametova, Astana (KZ); Nurlan Kuandykovich Smagulov, Astana (KZ); Svetlana Petrovna Novikova, Astana (KZ); Talgat Ergalievich Ibrayev, Astana (KZ); Zhanybek Zaydinovich Ashyrov, Astana (KZ); Linar Rinatovich Faizov, Astana (KZ)

(73) Assignee: JOINT STOCK COMPANY "NATIONAL RESEARCH CARDIACSURGERY CENTER", Astana (KZ)

(21) Appl. No.: 16/092,377

(22) PCT Filed: Dec. 2, 2016
(86) PCT No.: PCT/KZ2016/000019

§ 371 Date: Oct. 9, 2018

(51) Int. Cl. A01N 1/02

(52) U.S. Cl. CPC A01N 1/0226; A01N 1/0247

(57) ABSTRACT

In medicine, and more specifically, in cardiac surgery and perfusiology. In order to improve heart transplantation results by optimizing the conditioning of a heart, the method of conditioning a donor heart comprises a set of measures including an administration of a blood cardioplegic solution, an ultrafiltration and Levosimendan. For cardioplegia in the body of the donor, a normothermic solution consisting of donor blood and a crystalloid solution at the ratio of 5:1 (potassium chloride 4%, magnesium sulfate 25%, lidocaine 2%, sodium hydrocarbonate, and mannitol 15%) is used. To protect the myocardium and enhance its blood circulation, a single dose of Levosimendan (45 μg/kg) is injected into the perfusate. To remove inflammatory mediators, an excessive amount of fluid, and to correct the electrolyte composition and the hematocrit, the perfusate is ultrafiltered. Prior to transplantation to a recipient, the blood cardioplegic solution is administrated to wean the donor heart off the OCS device.

The invention relates to medicine, and specifically, to cardiosurgery and perfusiology.

Currently, an Organ Care System (OCS) mobile device is used for conditioning a donor heart during transportation. The system comprises new technologies for ensuring cardiac activity, which mimic the organ operation conditions outside of the body, thus allowing it to function close to its physiological state (http://www.pmewswire.co.uk/news-releases/297685301.html).

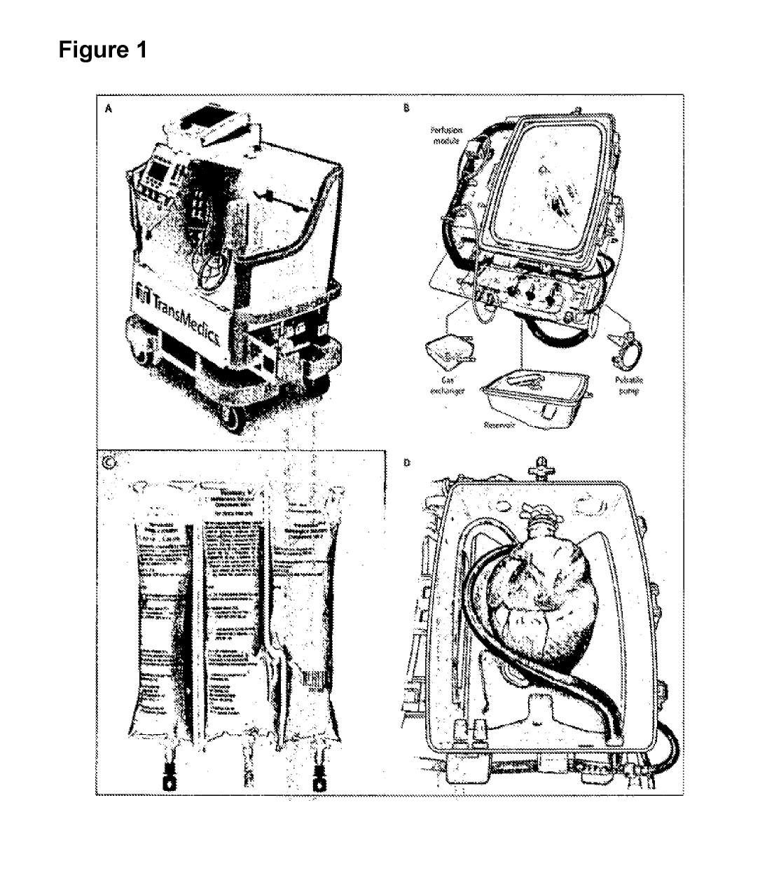

The system combines a compact wireless monitor, a special perfusion module and necessary solutions (FIG. 1). Both the aorta and pulmonary artery of the donor heart are cannulated and connected to the OCS device. In order to decompress the left ventricle, a drainage through the left atrium is arranged. A perfusate consisting of the donor blood (1200-1500 ml) and special solutions is used for a primary filling of the perfusion module volume. A standard method for stopping the donor heart consists in feeding 1000 ml of Custodiol hypothermic cardioplegic solution. Once the heart is connected to the OCS device and the sinus rhythm is restored, the OCS flow characteristics are adjusted to maintain the target aortic pressure between 60-90 mm Hg and coronary blood flow rate between 650-850 ml/min. To support coronary circulation, an isotonic solution with electrolytes, amino acids, insulin and adenosine is introduced into the perfusate at a frequency of 0-30 ml/h along with epinephrine at 10 ml/h. To support oxygenation of the heart, a gas mixture with a flow rate of 250-300 ml/min is used. (http://xn-dlaiegmcrih.xn-plai/). During perfusion, biochemical tests of the perfusate samples are routinely performed to assess the adequacy of perfusion. The samples are tested by using a portable analyzer. Upon recipient's arrival to a clinic of a recipient, and prior to implantation, the donor heart is stopped with the help of 1 liter of Custodiol hypothermic cardioplegic solution.

One of the disadvantages of using a Custodiol solution is the low potassium level. This dictates a need for introducing large volumes of the solution (1000 ml) as well as using longer exposure time to achieve a balance of ion concentration between the solution and the intracellular fluid of the heart.

In addition, after a single application of Custodiol solution, a prolonged cardioplegic effect develops (100-120 minutes), which significantly exceeds the time required for the heart to be placed in the OCS device and to renew the cardiac activity. The latter requires, on average, 20 minutes.

The objective of the present invention is to improve heart transplantation results by optimizing the conditioning of a heart by the described method. The method of conditioning a donor heart comprises a set of measures including an administration of a blood cardioplegic solution, an ultrafiltration and Levosimendan. For cardioplegia in the body of the donor, a normothermic solution consisting of donor blood and a crystalloid solution at the ratio of 5:1 (potassium chloride 4%, magnesium sulfate 25%, lidocaine 2%, sodium hydrocarbonate, and mannitol 15%) is used. To protect the myocardium and enhance its blood circulation, a single dose of Levosimendan (45 μg/kg) is injected into the perfusate. To remove inflammatory mediators, an excessive amount of fluid, and to correct the electrolyte composition and the hematocrit, the perfusate is ultrafiltered. Prior to transplantation to a recipient, the blood cardioplegic solution is administrated to wean the donor heart off the OCS device.

The advantage of using a blood solution for cardioplegia is the high concentration of potassium ions in the solution, which facilitates faster stopping of the heart with the duration of safe anoxia of the myocardium of 20 minutes. The cardioplegic effect is enhanced by lidocaine contained in the solution, which stabilizes the myocardium, causing a delay in the reactivation of the fast sodium channels of the cardiomyocyte membrane. In addition, the advantages of blood cardioplegia are associated with high oxygen and buffer capacity of the red blood cells; the presence of energy and plastic substrates to sustain myocardial metabolism; adequate colloid osmotic pressure to prevent the development of intracellular edema; the presence of natural antioxidants to reduce the risk of reperfusion injury; and a reduction in total hemodilution during surgery, which is especially important in case of prolonged myocardial ischemia and its reduced functional capabilities.

The proposed method has undeniable advantages in comparison with the standard method (Custodiol) for protecting the myocardium.

TABLE 1
Composition of blood cardioplegia 600 ml:

| | | |
|---|---|---|
| KCl 4% | 30 | ml |
| MgS0₄ 25% | 10 | ml |
| Lidocaine 2% | 2 | ml |
| NaHCO₃ | 13 | ml |
| Mannitol 15% | 6.5 | ml |
| Blood | up to a volume of 600 | ml |

1. A method of conditioning a donor heart during transportation by using an OCS, comprising:
administering a blood cardioplegic solution,
performing an ultrafiltration, and
administering Levosimendan,
wherein the method comprises:
introducing Levosimendan into a perfusate,
removing inflammatory mediators,
eliminating an excess of fluid,
achieving a correction of electrolyte composition and of hematocrit by ultrafiltration of the perfusate, and
prior to transplantation to a recipient of the heart to be weaned off the OCS device, administering the blood cardioplegic solution.
